(19) United States
(12) Patent Application Publication
(10) Pub. No.: US 2008/0094110 A1
(43) Pub. Date: Apr. 24, 2008

(54) Transconductor Circuits

(75) Inventor: John B. Hughes, Hove (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,639

(22) PCT Filed: Jul. 28, 2005
(86) PCT No.: PCT/IB05/52543

§ 371 Date: Jan. 25, 2007

(30) Foreign Application Priority Data
Jul. 30, 2004 (GB) 0416977.7

(51) Int. Cl. H02M 11/00

(52) U.S. Cl. 327/103

(57) ABSTRACT

The invention relates to transconductor circuits, particularly but not exclusively to a single-ended transconductor circuit (50), balanced transconductor circuits and a filter suitable for use in a wireless transceiver. The single-ended transconductor (50) comprises an inverter (51) having an input (54) and an output (55). A resistive element (58) is connected between the input (54) and the output (55).

The invention relates to transconductor circuits, particularly but not exclusively to a single-ended transconductor, a balanced transconductor circuit and a filter suitable for use in a wireless transceiver.

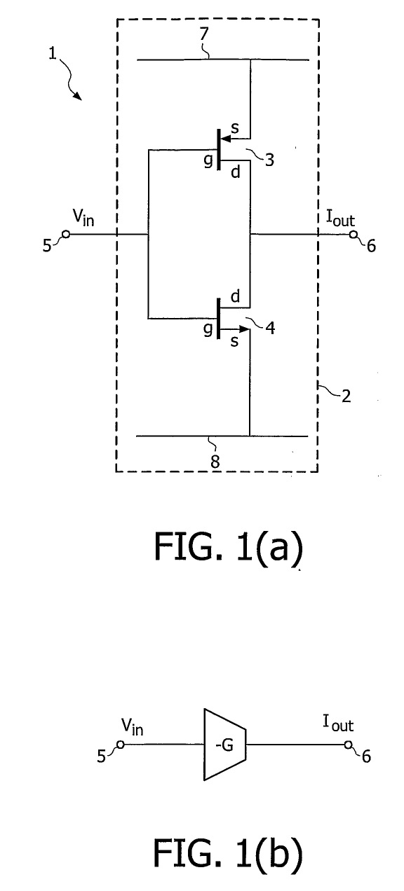

It is known to use class AB transconductors in gyrator channel filters for modern wireless transceivers, for instance transceivers that operate according to Bluetooth™ and ZigBee™ standards. An example of a conventional single-ended transconductor 1 that can be used in such filters is illustrated in FIG. 1(a). A CMOS inverter 2 comprises a p-channel metal-oxide semiconductor field effect transistor (MOSFET) 3 and an n-channel MOSFET 4. The p-channel and n-channel MOSFETs 3, 4 have equal transconductances, gₘ, and are arranged with their gate terminals, g, connected to an input terminal 5 and their drain terminals, d, connected to an output terminal 6. The source terminal of the p-channel MOSFET 3 is connected to a first power supply rail 7 and the source terminal of the n-channel MOSFET 4 is connected to a second power supply rail 8.

In use, an input voltage Vᵢₙ is applied at the input terminal 5 and an output current lout is provided at the output terminal 6. The overall transconductance, -G, of the single-ended transconductor 1 is −2 gₘ. FIG. 1(b) is a schematic illustration of the single-ended transconductor of FIG. 1 (a).

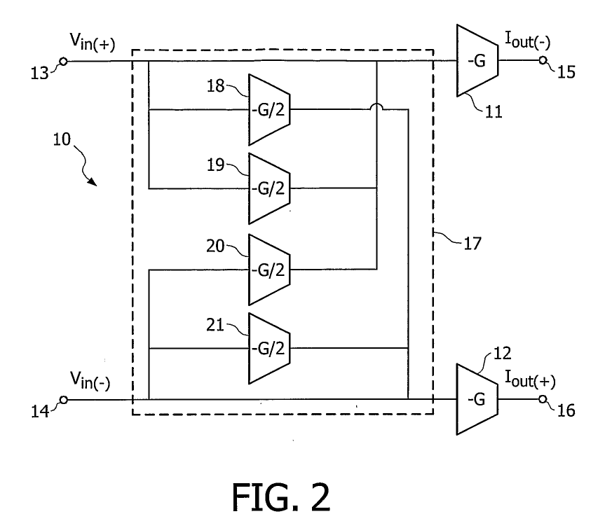

Each gyrator in a gyrator channel filter typically includes a balanced transconductor circuit. FIG. 2 is a schematic illustration of a known balanced feedback transconductor circuit 10 as can be used in a gyrator channel filter. First and second transconductors 11, 12 each comprise a single-ended transconductor circuit similar to that illustrated in FIG. 1(a). The first transconductor 11 is connected to a positive input terminal 13, which, in use, receives a positive input voltage, Vᵢₙ₍₊₎. The second transconductor 12 is connected to a negative input terminal 14, which, in use, receives a negative input voltage, Vᵢₙ₍₋₎. In use, a negative output current, Iₒᵤₜ₍₋₎, is provided at the output of the first transconductor 11, which is connected to a negative output terminal 15. A positive output current, Iₒᵤₜ₍₊₎, is provided at the output of the second transconductor 12, which is connected to a positive output terminal 16. An input arrangement 17 provides common-mode feedback and is formed by four transconductors 18, 19, 20, 21. Each of the four transconductors comprises half-width transistors and therefore has half the bias current and transconductance (-G/2) of full-sized transconductors. This results in stable operation.

Whilst the common-mode feedback input arrangement 17 can have benefits of improved stability, reduced power consumption and increased common-mode rejection over designs not having common-mode feedback, in use, at least half of the total power consumption in the balanced transconductor circuit 10 is in the input arrangement 17. Furthermore, at least half of the balanced transconductor's noise, area and input capacitance is a direct result of the input arrangement 17, this leading to further power consumption penalties.

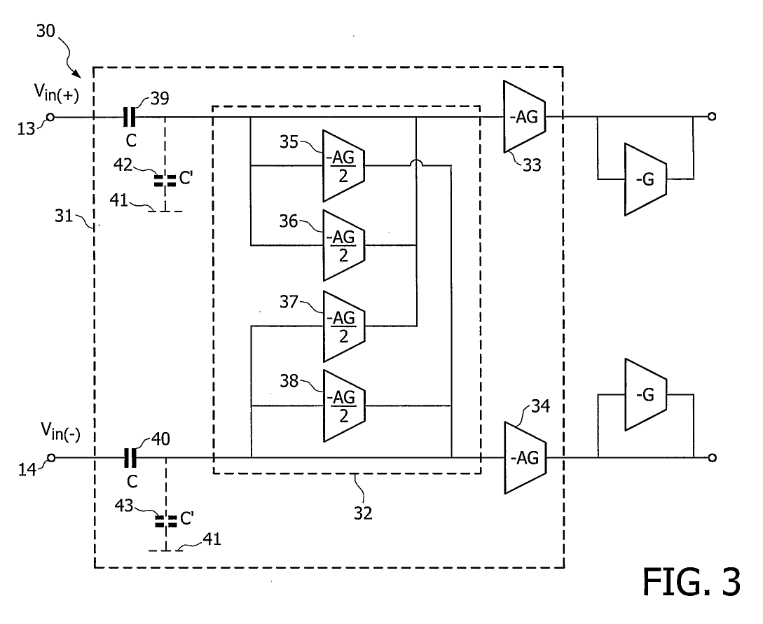

FIG. 3 illustrates a portion 30 of a conventional gyrator channel filter using a conventional balanced transconductor circuit in each gyrator stage. The gyrator channel filter has an input stage 31 comprising a known balanced feedback transconductor circuit having a common-mode input arrangement 32 similar to the input arrangement 17 previously described with reference to FIG. 2. The usual architecture for such gyrator channel filters is known as the “active ladder”, which simulates the operational behaviour of a double terminated LCR ladder arrangement and typically has a gain of approximately −6 dB. However, since channel filters are usually required to have gains of 20 dB to 30 dB, it is necessary to add input and/or output gain stages. In this example the input filter stage 31 comprises an additional gain A to provide the appropriate front-end amplification. The single-ended transconductors 33, 34 in the balanced transconductor circuit of the input stage 31 therefore have transconductances of -AG. The half-sized single-ended transconductors 35, 36, 37, 38 of the input arrangement 32 have transconductances of -AG/2.

The input stage 31 is also required to provide direct current (dc) blocking of signals from the mixer (not shown) of the wireless transceiver circuitry and therefore the input stage comprises two blocking capacitors 39, 40 each having a capacitance C.

The circuit 30 has an effective input capacitance C′ between the inputs of each of the first and second transconductors 33, 34 and a ground terminal 41, illustrated in FIG. 3 by dashed capacitors 42, 43. Each of the input capacitances C′ is dependent on the magnitude of the transconductance of the single-ended transconductors 35, 36, 37, 38 in the input arrangement 32. These relatively large input capacitances C′ necessitate the use of dc blocking capacitors 39, 40 having large capacitances, C, if attenuation through capacitive division (C/(C+C′)) is to be minimised. The dc blocking capacitors 39, 40, due to their size, each require a relatively large substrate area, which is undesirable in modern applications.

Therefore, the arrangement of FIG. 3 can be noisy, can consume more power than is necessary, and occupies an unacceptable substrate area.

The present invention seeks to overcome these drawbacks.

According to the invention from a first aspect there is provided a single-ended transconductor comprising an inverter having an input and an output, and a resistive element connected between the input and the output.

Having a resistive element connected in this way has the advantage of providing a means for biasing the input terminal. The resistive element can result, in operation of the circuit, in a low-pass feedback path from the output to the input of the transconductor, this being formed by the resistive element and a transconductor input capacitance C′. The dc voltage at the input and output terminals is therefore substantially equal. This is advantageous in certain applications and, for instance, enables the single-ended transconductor to form a component of a balanced transconductor circuit that can avoid the penalties associated with conventional common mode feedback circuits.

The inverter can comprise an NMOS transistor and a PMOS transistor, each having their gates connected to the input and their drains connected to the output.

The resistance of the resistive element is preferably substantially greater than the inverse of the magnitude of the transconductance of the single-ended transconductor. This can ensure that the cut-off frequency of the low-pass feedback path created by the resistive element and the input capacitance C′ is relatively low. Accordingly, there can be negligible alternating current (ac) signal feedback, and signal transmission through the transconductor can be substantially unimpaired.

Preferably, the resistive element is a transistor. Using a transistor can have the advantage of requiring less substrate area in comparison to using a resistor. An input terminal of the transistor can be connected to one of the first and second power supply rails. When this is the case, the resistance of the transistor can be predetermined by setting the dimensions of the transistor, for instance the dimensions of the source, drain and gate regions of the transistor, accordingly.

A balanced transconductor circuit can be formed from a pair of single-ended transconductors according to the invention.

This balanced transconductor may not be used in the internal feedback loops of gyrator channel filters as the feedback leads to instability and therefore a conventional common mode feedback arrangement is required. However, this balanced transconductor can be used in applications where feedback loops are not required such as the input and output stages of filters. The use of conventional input arrangements in such input and output stages can result in overly poor filter characteristics, the problems of which the balanced transconductor according to the present invention can overcome. The balanced transconductor has the advantage that it provides its own means for biasing the input terminals without the penalties of the common-mode feedback circuit.

According to the invention from a second aspect there is provided a balanced transconductor circuit comprising a first transconductor arranged between a first input terminal and a first output terminal, a second transconductor arranged between a second input terminal and a second output terminal, a first resistive element connected between the first input terminal and the first output terminal, a second resistive element connected between the second input terminal and the second output terminal, a third resistive element connected between the first input terminal and the second output terminal, and a fourth resistive element connected between the second input terminal and the first output terminal.

This transconductor circuit can have the advantage of blocking low-frequency differential input signals whilst at the same time having a relatively high cut-off frequency for common-mode signals, thus resulting in the circuit having a high common-mode rejection ratio. This circuit can be advantageous in applications such as the input and output stages of filters, where high levels of stabilisation are not necessarily required to the extent that they can be required in other applications such as a filter's internal feedback loops.

Preferably, at least one of the first, second, third and fourth resistive elements is a transistor. An arrangement using a transistor for one or more of the resistive elements can have the advantage of requiring less substrate area in comparison to an arrangement using a resistor. An input terminal of the transistor can be connected to one of the first and second power supply rails. In this case, the resistance of the transistor can be predetermined by setting the dimensions of the transistor, for instance the dimensions of the source, drain and gate regions of the transistor, accordingly.

A filter can be formed including an input stage comprising the balanced transconductor circuit.

In this filter, low frequency differential signals can be blocked without impairing the filter response, thus avoiding the need for large blocking capacitors in the input stage. This can reduce the size of the capacitors required and therefore reduce the substrate area required for the filter. Also, the cut-off frequency for common-mode signals can be higher than in conventional circuits thus resulting in the circuit having a high common-mode rejection ratio. Power-saving advantages can also be achieved due to a minimisation of input-referred noise in the filter and a reduction in the overall power consumption of components in the filter.

A filter can be formed including an output stage comprising the balanced transconductor circuit.

This filter can have the particular advantage of blocking low frequency common-mode signals that can arise from the gyrator filter as a result of random transistor mismatches.

In order that the invention may be more fully understood, embodiments thereof will now be described, purely by way of example, with reference to the accompanying drawings, in which:

FIG. 1(a) illustrates a conventional single-ended transconductor circuit;

FIG. 1(b) is a schematic illustration of a single-ended transconductor;

FIG. 2 is a schematic illustration of a conventional balanced feedback transconductor circuit;

FIG. 3 illustrates a portion of a conventional gyrator channel filter;

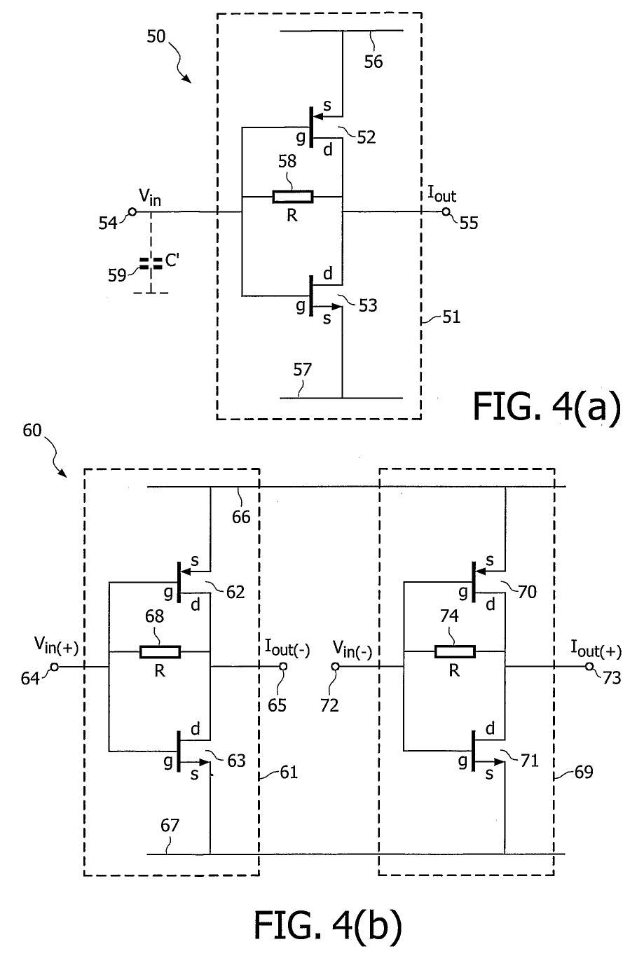

FIG. 4(a) illustrates a single-ended transconductor circuit according to the invention;

FIG. 4(b) illustrates a balanced transconductor circuit according to the invention formed by two of the single-ended transconductor circuits of FIG. 4(a);

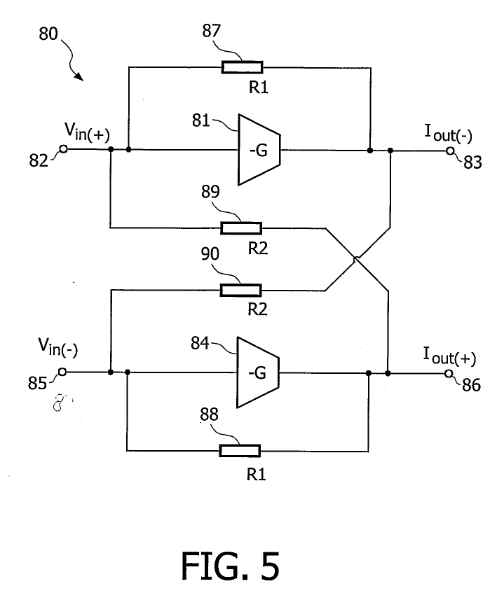

FIG. 5 is a schematic illustration of one example of a balanced feedback transconductor circuit according to the invention;

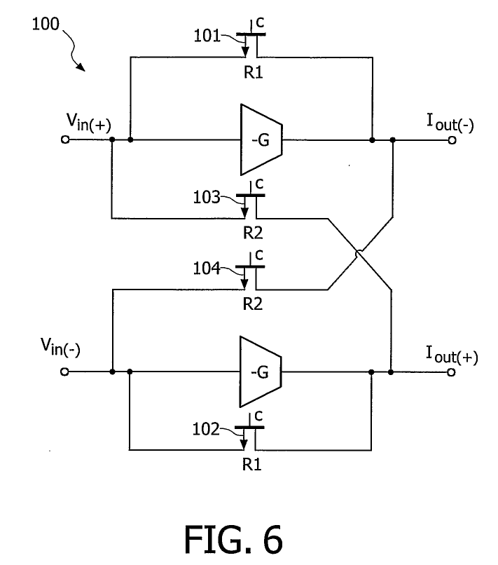

FIG. 6 is a schematic illustration of another example of a balanced feedback transconductor circuit according to the invention; and

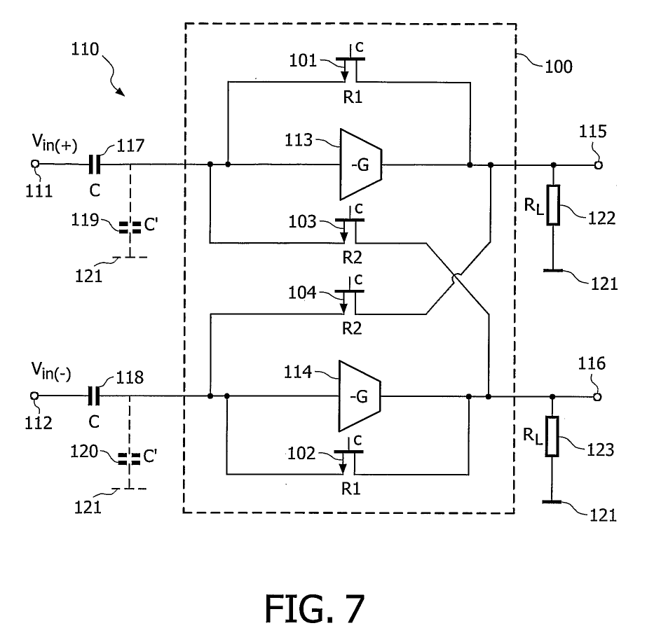

FIG. 7 illustrates a portion of a gyrator channel filter according to the invention.

FIG. 4(a) illustrates a single-ended transconductor circuit 50 according to the invention. In this example, a CMOS inverter 51 comprises a p-channel MOSFET 52 and an n-channel MOSFET 53. The p-channel and n-channel MOSFETs 52, 53 have equal transconductances, gₘ, and are arranged with their gate terminals, g, connected to an input terminal 54 and their drain terminals, d, connected to an output terminal 55. The source terminal of the p-channel MOSFET 52 is connected to a first power supply rail 56 and the source terminal of the n-channel MOSFET 53 is connected to a second power supply rail 57. A resistor 58 having a resistance R is arranged between the input and output terminals 54, 55.

In use, a voltage source is connected across the first and second power supply rails 56, 57, an input voltage Vᵢₙ is applied at the input terminal 54 and an output current Iₒᵤₜ is thus provided at the output terminal 55.

The single-ended transconductor of FIG. 4(a) can be considered to be the single-ended transconductor of FIG. 1(a) with a low pass feedback path formed by the combination of the resistor 58 and a transconductor input capacitance C′, illustrated by a dashed capacitor 59 in FIG. 4(a). The dc voltage at the input and output terminals 54, 55 is therefore substantially equal.

So long as the cut-off frequency of the low pass filter is low, there is negligible signal feedback and the signal transmission through the transconductor is substantially unimpaired. Accordingly, the resistance R of the resistor 58 is preferably set to be substantially greater than 1/G, where -G is the overall transconductance of the single-ended transconductor circuit 50.

Although a resistor 58 is used to provide dc feedback in the example of FIG. 4(a), this element can be replaced by an alternative resistive element such as a transistor. An arrangement using a transistor can have the advantage of having reduced substrate area in comparison to the illustrated arrangement using a resistor. In one example, the main current path of the transistor is connected between the input and output terminals 54, 55 and the input terminal is connected to a constant voltage source. For instance, in the case that a MOSFET is used, the source is connected to the input terminal 54, the drain is connected to the output terminal 55 and the gate is connected to the first power supply rail 56. The resistance of the main current path of the MOSFET would be predetermined by setting the dimensions of the MOSFET accordingly, for instance the width of the source, drain and gate regions of the MOSFET. Alternatively, the magnitude of the control signal applied to the gate of the MOSFET or other transistor used could be selectively set to give the transistor its appropriate resistance, R.

FIG. 4(b) illustrates a balanced transconductor circuit 60 according to the invention formed by two single-ended transconductor circuits each similar to that illustrated in FIG. 4(a). A first inverter 61 comprises a first p-channel MOSFET 62 and a first n-channel MOSFET 63. The first p-channel and n-channel MOSFETs 62, 63 have equal transconductances, gm, and are arranged with their gate terminals, g, connected to a positive input terminal 64 and their drain terminals, d, connected to a negative output terminal 65. The source terminal of the p-channel MOSFET 62 is connected to a first power supply rail 66 and the source terminal of the n-channel MOSFET 63 is connected to a second power supply rail 67. A first resistor 68 having a resistance R is arranged between the positive input and negative output terminals 64, 65.

A second inverter 69 comprises a second p-channel MOSFET 70 and a second n-channel MOSFET 71. The second p-channel and n-channel MOSFETs 70, 71 have equal transconductances, gₘ, and are arranged with their gate terminals, g, connected to a negative input terminal 72 and their drain terminals, d, connected to a positive output terminal 73. The source terminal of the p-channel MOSFET 70 is connected to the first power supply rail 66 and the source terminal of the n-channel MOSFET 71 is connected to the second power supply rail 67. A second resistor 74 having a resistance R is arranged between the negative input and positive output terminals 72, 73.

In operation, a voltage source is connected across the first and second power supply rails 66, 67. The positive input terminal 64 receives a positive input voltage Vᵢₙ₍₊₎ and the negative input terminal 72 receives a negative input voltage. The positive output terminal 73 provides a positive output current Iₒᵤₜ₍₊₎ and the negative output terminal 65 provides a negative output current lout( ).

Each of the two single-ended transconductor circuits is therefore used to convert either a positive or a negative input voltage to a negative or positive output current respectively. The first and second resistors are not limited to having the same resistance, R, but could have different resistances. Either or both of the resistors may alternatively be replaced with a transistor such as a MOSFET in a similar manner to that described above with reference to FIG. 4(a). The resulting balanced transconductor circuit 60, as well as the individual single-ended transconductor 50, can have applications in circuits such as the input and output stages of gyrator channel filters, for instance those suitable for use in wireless transceivers that operate according to Bluetooth™ and/or ZigBee™ standards.

FIG. 5 is a schematic illustration of one example of a balanced transconductor circuit 80 according to the invention. A first conventional single-ended transconductor 81, for instance as illustrated in FIG. 1(a) and having a transconductance -G, is arranged with its input connected to a positive input voltage terminal 82 and its output connected to a negative output current terminal 83. A second conventional single-ended transconductor 84, for instance as illustrated in FIG. 1(a) and having a transconductance -G, is arranged with its input connected to a negative input voltage terminal 85 and its output connected to a positive output current terminal 86. A first resistive element 87 has a resistance R1 and is connected between the positive input voltage terminal 82 and the negative output current terminal 83. A second resistive element 88 has a resistance R1, in this example equal to the resistance of the first resistive element 87, and is connected between the negative input voltage terminal 85 and the positive output current terminal 86. A third resistive element 89 has a resistance R2 and is connected between the positive input voltage terminal 82 and the positive output current terminal 86. A fourth resistive element 90 has a resistance R2, in this is example equal to the resistance of the third resistive element 89, connected between the negative input voltage terminal 85 and the negative output current terminal 83. First, second, third and fourth resistive elements 87, 88, 89, 90 are resistors in this embodiment.

This circuit 80, for instance when included in circuits such as filter circuits, can have the advantage of blocking low-frequency differential input signals whilst at the same time having a relatively high cut-off frequency for common-mode signals, thus resulting in the circuit having a high common-mode rejection ratio. With a differential input voltage present and with, in one example, R1=R2, the feedforward and feedback via the resistive elements is cancelled.

FIG. 6 illustrates another example of a balanced transconductor circuit 100 according to the invention, similarly arranged to the circuit described with reference to FIG. 5, but in which the first, second, third and fourth resistive elements are n-type MOSFETs 101, 102, 103, 104. Each of the MOSFETs is arranged with its main current path between an output and an input of the balanced transconductor circuit 100 and is supplied with a control signal ‘c’ at a gate terminal such that it operates in a triode or linear region. The gates could be connected to a supply rail (not shown) of the circuit 100. This enables the MOSFETs 101, 102, 103, 104 to operate in a similar manner as variable resistors, their resistance being dependent on the dimensions of the MOSFET, for instance the dimensions of the source, drain and/or gate regions. The use of MOSFETs as resistive elements in this circuit 100 results in an arrangement having reduced substrate area when compared to a circuit such as that previously described 80 using resistors. The resistances R1 and R2 can be set to be equal, in order to cancel out feedback and feedforward signals, or may alternatively be set individually to allow greater control over the operational characteristics of the circuit 100, as will be described.

FIG. 7 illustrates an input stage 110 of a filter according to the invention comprising a balanced transconductor circuit 100 as previously described with reference to FIG. 6. In this example the filter is a gyrator channel filter for use in a wireless transceiver. The input stage comprises positive and negative input terminals 111, 112 connected to the inputs of first and second single-ended transconductors 113, 114 respectively. The input stage 110 has first and second output terminals 115, 116 for connecting to the next stage in the filter.

The input stage 110 has dc blocking capacitors 117, 118 each having capacitance C and arranged in series between the input terminals 111, 112 and the first and second single-ended transconductors 113, 114 respectively. An effective input capacitance C′, illustrated in FIG. 7 by dashed capacitors 119, 120, is present between each of the first and second single-ended transconductor 113, 114 inputs and a ground terminal 121 respectively. Resistive loads 122, 123 of value R_{L} are present between each of the output terminals 115, 116 and the ground terminal 121 respectively.

For a filter input stage receiving differential-mode signals, such as that illustrated in FIG. 7, and in the case in which R1, the resistance of the first and second resistive elements, is not set equal in value to R2, the resistance of the third and fourth resistive elements, this produces a first-order high pass response with a cut-off frequency of w_{co} given by,

$${ω}_{co} \approx \frac{1 + {G}_{m} {R}_{L}}{{CR}_{F}} ,$$

where R_{F}, the effective feedthrough resistance, is given by,

$${R}_{F} = \frac{{R}_{1} {R}_{2}}{{R}_{2} - {R}_{1}} ,$$

and an approximate high frequency gain, A, is given by A≈-GₘR_{L}.

For common-mode input signals, the effective feedthrough resistance becomes,

$${R}_{F ( c m )} = \frac{{R}_{1} {R}_{2}}{{R}_{2} + {R}_{1}} .$$

Accordingly, the value of R1 and R2 can be chosen such that low frequency differential signals are blocked thus avoiding the need for large blocking capacitors 117, 118, without impairing the channel filter response. Also, the cut-off frequency for common-mode signals can be much higher thus resulting in the circuit 110 having a high common-mode rejection ratio.

The example depicted in FIG. 7 is an input stage for a gyrator channel filter for a Bluetooth™ wireless transceiver. Component values for the circuit could be, for example, blocking capacitances, C, set to 10 pF, resistive loads, R_{L}, equal to 12.5 kΩ and the transconductance, G, equal to 320 μS. Setting R1 to 1 MΩ and R2 to 1.1 MΩ results in an effective feedthrough resistance, R_{F}, of 11 MΩ. The n-type MOSFET transistors used as the first and second resistive elements 101, 102, can, for example, have widths of 0.28 μm and lengths of 42 μm. The n-type MOSFET transistors used as the third and fourth resistive elements 103, 104 can, for example, have widths of 0.28 μm and lengths of 46 μm. Using the above formulae, the cut-off frequency is thus approximately 7.2 kHz and the high frequency gain, A, is approximately 4. For common-mode signals, the cut-off frequency is larger, at approximately 152 kHz.

When the above component values are used in a simulation of the circuit of FIG. 7, the dc blocking capacitors 117, 118 require substrate areas of about 1160 μm² each in comparison to the 62 pF capacitors requiring an area of about 7200 μm² that can be required with a conventional prior art circuit such as that depicted in FIG. 3. The input referred noise density is also reduced from that of the prior art design, this being 37 nV/√ Hz in the example of FIG. 7 compared to 45 nV/√ Hz in a conventional design. The actual power consumption is also reduced by 11%, which, when combined with the implied power saving resulting from the input referred noise reduction, results in total filter power savings of about 40%.

In an alternative example, the balanced transconductor circuit 100 of FIG. 6 can be used in the output stage of a filter such as a gyrator channel filter for use in a wireless transceiver that operates according to Bluetooth™ and/or ZigBee™ standards. In this case, the circuit would have the advantage of blocking low frequency common-mode signals that can arise from the gyrator filter as a result of random mismatches of its transistors.

From reading the present disclosure, other variations and modifications will be apparent to persons skilled in the art. Such variations and modifications may involve equivalent and other features which are already known in the design, manufacture and use of transconductor circuits and which may be used instead of or in addition to features already described herein.

Although claims have been formulated in this application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further applications derived therefrom.

1. A single-ended transconductor (50) comprising:
an inverter (51) having an input (54) and an output (55); and
a resistive element (58) connected between the input (54) and the output (55).

2. A single-ended transconductor according to claim 1, wherein the inverter comprises an NMOS transistor (52) and a PMOS transistor (53), each having their gates connected to the input (54) and their drains connected to the output (55).

3. A single-ended transconductor according to claim 1, wherein the resistance (R) of the resistive element (58) is substantially greater than the inverse of the magnitude of the transconductance of the single-ended transconductor (50).

4. A single-ended transconductor according to claim 1, wherein the resistive element (58) is a resistor.

5. A single-ended transconductor according to claim 1, wherein the resistive element (58) is a transistor.

6. A single-ended transconductor according to claim 5, wherein the transistor is arranged to operate in its triode region.

7. A single-ended transconductor according to claim 5, wherein a gate terminal of the transistor is connected to one of first and second power supply rails (56, 57).

8. A single-ended transconductor according to claim 5, wherein the transistor is an NMOS field effect transistor.

9. A balanced transconductor circuit (60) comprising a pair of single-ended transconductors (50) according to claim 1.

10. A balanced transconductor circuit (80, 100) comprising:
a first transconductor (81, 113) arranged between a first input terminal (82, 111) and a first output terminal (83, 115);
a second transconductor (84, 114) arranged between a second input terminal (85, 112) and a second output terminal (86, 116);
a first resistive element (87, 101) connected between the first input terminal (82, 111) and the first output terminal (83, 115);
a second resistive element (88, 102) connected between the second input terminal (85, 112) and the second output terminal (86, 116);
a third resistive element (89, 103) connected between the first input terminal (82, 111) and the second output terminal (86, 116); and
a fourth resistive element (90, 104) connected between the second input terminal (85, 112) and the first output terminal (83, 115).

11. A balanced transconductor circuit according to claim 10, wherein at least one of the first, second, third and fourth resistive elements is a transistor.

12. A balanced transconductor circuit according to claim 11, wherein the transistor is arranged to operate in its triode region.

13. A balanced transconductor circuit according to claim 11, wherein a gate terminal of at least one of the first, second, third and fourth transistors is connected to one of first and second power supply rails.

14. A balanced transconductor circuit according to claim 11, wherein at least one of the first, second third and fourth transistors is an NMOS field effect transistor.

15. A balanced transconductor circuit according to claim 10, wherein the resistance of the first resistive element (87, 101) is a first value (R1) that is equal to the resistance of the second resistive element (88, 102) and wherein the resistance of the third resistive element (89, 103) is a second value (R2) that is equal to the resistance of the fourth resistive element (90, 104).

16. A balanced transconductor circuit according to claim 15, wherein the first and second values (R1, R2) are different.

17. A balanced transconductor circuit according to claim 10, wherein:
the first and second input terminals (82, 111, 85, 112) are arranged to receive positive and negative voltage input signals respectively; and
the first and second output terminals (83, 115, 86, 116) are arranged to provide positive and negative current output signals respectively.

18. A filter including an input stage (110) comprising a balanced transconductor circuit (80, 100) according to claim 9.

19. A filter according to claim 18, further comprising a first capacitor (117) connected in series between the first input terminal (111) and the input of the first transconductor (113), and a second capacitor (118) connected in series between the second input terminal (112) and the input of the second transconductor (114).

20. A filter including an output stage comprising a balanced transconductor circuit (80, 100) according to claim 9.

21. A filter according to claim 18, wherein the filter is a gyrator channel filter for use in a wireless transceiver.

22. A filter according to claim 21, wherein the wireless transceiver operates according to Bluetooth™ or ZigBee™ standards.
